(19) United States
(12) Patent Application Publication
(10) Pub. No.: US 2004/0160595 A1
(43) Pub. Date: Aug. 19, 2004

(54) Road marking evaluation and measurement system

(75) Inventors: Aleksandar Zivkovic, Woodbridge (CA); Ilya Voronov, Mississauga (CA); David P. Villani, Acworth, GA (US)

Correspondence Address: RANKIN, HILL, PORTER & CLARK, LLP, 925 EUCLID AVENUE, SUITE 700, CLEVELAND, OH, 44115-1405, US

(73) Assignee: Lafarge Road Marking, Inc., Parsippany, NJ

(21) Appl. No.: 10/367,602

(22) Filed: Feb. 14, 2003

(51) Int. Cl. G01J 3/46; G01B 11/28

(52) U.S. Cl. 356/73; 356/402; 356/630

(57) ABSTRACT

An apparatus for measuring attributes such as color, thickness and/or retro reflectivity of a road marking disposed on a road surface. The apparatus includes a vehicle that travels over the road surface. The vehicle transports a measurement system and a computer. The measurement system includes at least one subsystem, which may include a color measurement subsystem, a thickness measurement subsystem and/or a retro-reflectivity measurement subsystem. The computer receives the measurement information from the measurement system.

### FIELD OF THE INVENTION

The present invention relates generally to an apparatus for evaluating road markings and, more particularly, to an apparatus for measuring and evaluating the color, thickness and/or retro-reflectivity of road markings applied to a road surface.

### DESCRIPTION OF RELATED ART

The term “road marking” as used herein means any indicia applied to the surface of a road to visually provide important information such as the location of right-of-ways to users of the road. Common examples of road markings include single centerlines, double and/or dashed centerlines, shoulder demarcation lines, cross walks, stop bars, and emergency lane lines. Road markings can be applied to road surfaces in many forms such as paints, thermoplastic tapes, or molten thermoplastic sprays or extrusions.

Several measurable factors or parameters are useful in predicting the visual-information-transmitting effectiveness and longevity of applied road markings. These factors or parameters include the color of the road marking, the thickness of the road marking and the retro-reflectivity of the road marking.

Over time, the visual-information-transmitting effectiveness of road markings tends to deteriorate. This deterioration is typically the product of physical damage caused by prolonged exposure to vehicle traffic and/or chemical damage caused by prolonged exposure to environmental conditions (e.g., sunlight, precipitation and road salt). Abrasive wear caused by prolonged exposure to vehicle traffic can physically reduce the thickness of road markings to an undesirable level thereby making the road markings difficult for users of the road to visually discern. Similarly, prolonged exposure to sunlight and other environmental conditions can cause the color of road markings to fade thereby making them difficult to visually discern.

Accurate periodic inspection and/or monitoring of the visual-information-transmitting effectiveness of road markings is important in order to maintain the safety of roadways. Furthermore, accurate periodic inspection and/or monitoring of the visual-information-transmitting effectiveness of road markings is important in planning and decision-making, such as budgeting materials spending and establishing repair and/or replacement priorities.

Conventionally, road markings are inspected and/or monitored using a variety of devices. Thickness measurements, for example, are conventionally made using a contact probe, which is placed stationary on the road marking, or using a laser triangulation device, which measures the shift of the laser beam reflected from a surface at an angle. Color measurements, for example, are conventionally made using spectroscope or a color sensor. In order to make such a measurement, a special calibrated light source must be placed stationary on the marked road surface. The measurement area must then be enclosed to protect or shield the area from ambient light, which distorts the measurement. And, retro-reflectivity measurements are conventionally made using a light source and a photo-sensor array with long focus optics, a narrow-spectrum visible laser, a low power source, a photo-multiplier unit with a narrow band filter that corresponds to the narrow-spectrum laser, a modulated laser source, and a photodiode array. Conventional retro-reflectivity measuring devices typically use low incidence angles to simulate the conditions of the vehicle on the road and the headlight position relative to the driver's position.

Heretofore, a separate measuring device must be used in order to measure each factor or parameter (e.g., color, thickness and retro-reflectivity) of the road marking. Some of these devices must be manually operated by specially-trained personnel in order to obtain accurate measurements. This places road marking inspectors on the road, where they are exposed to a risk of injury or death due to the proximity of vehicular traffic. Alternatively, vehicular traffic must be rerouted or stopped during the inspection, thus rendering the roadway unusable during the inspection period.

### SUMMARY OF THE INVENTION

The present invention provides an apparatus and method for measuring certain attributes or parameters of road markings such as the color, thickness or retro-reflectivity. The apparatus comprises a vehicle, which can be moving or stationary when measurements are being made. In particular, the apparatus according to the invention includes a vehicle that travels over a road surface and transports a measurement system, which communicates with a computer. The measurement system can comprises a plurality of subsystems, for example a color measurement system, a thickness measurement system and a retro-reflectivity measurement system, each of which can generate measurement information regarding road marking parameters corresponding to the particular subsystem. The computer receives measurement information from the measurement system.

As the vehicle is driven over the road surface, the measurement system measures a parameter of the road markings that pass in front of or beneath the various subsystems of the measurement system. The system according to the invention facilitates the safe, accurate, and expedient inspection and/or monitoring parameters such as the color, thickness and retro-reflectivity of applied road markings so that planning and decisions can be made to insure that the visual-information-transmitting effectiveness of road markings is maintained.

### BRIEF DESCRIPTION OF THE DRAWINGS

FIG. 1 is a block diagram of an embodiment of an apparatus for evaluating road markings according to the present invention;

FIG. 2 is a schematic side view of an apparatus for measuring and evaluating road markings according to the present invention;

FIG. 3 is a schematic perspective view of a thickness measurement subsystem according to the present invention;

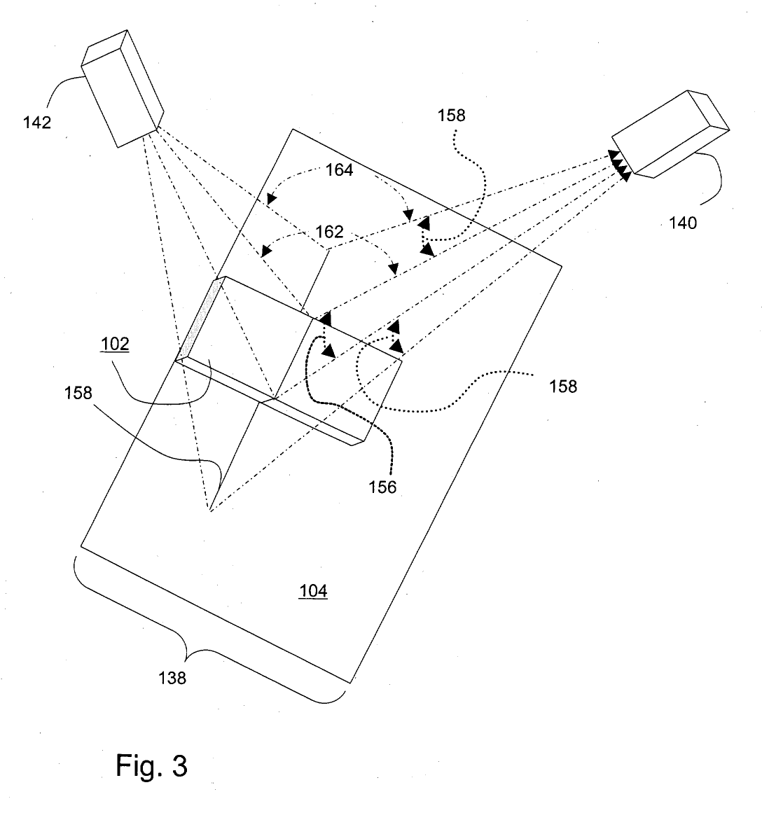

FIG. 4 is a schematic side view of a retro-reflectivity measurement subsystem according to the present invention; and

FIG. 5 is a schematic front view of the retro-reflectivity measurement subsystem shown in FIG. 4.

### DETAILED DESCRIPTION OF PREFERRED EMBODIMENTS

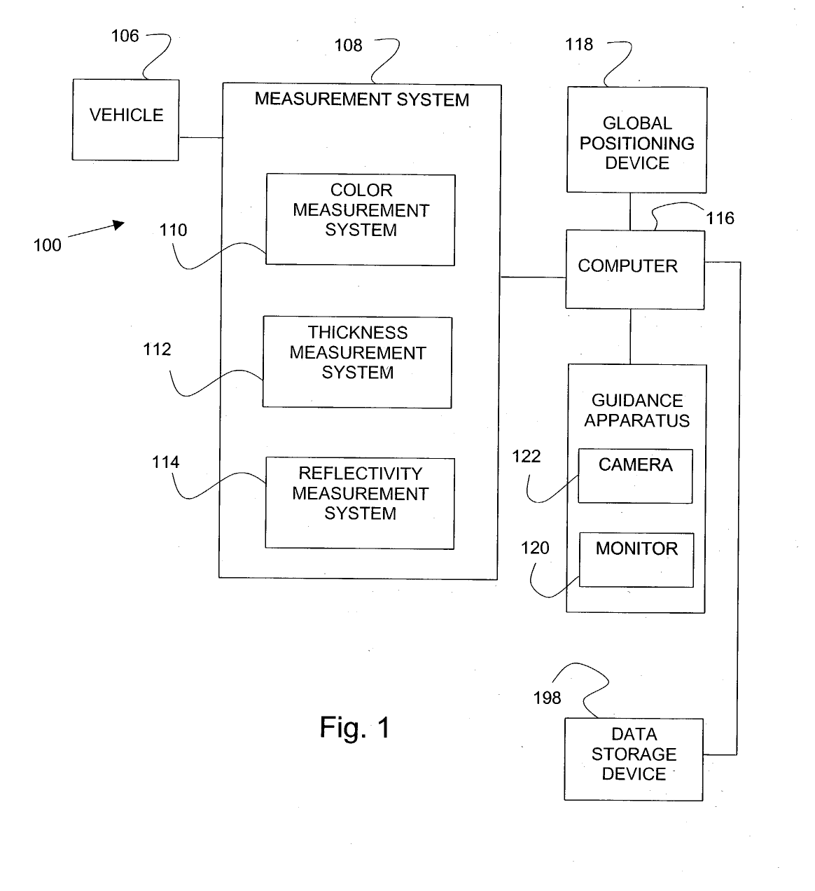

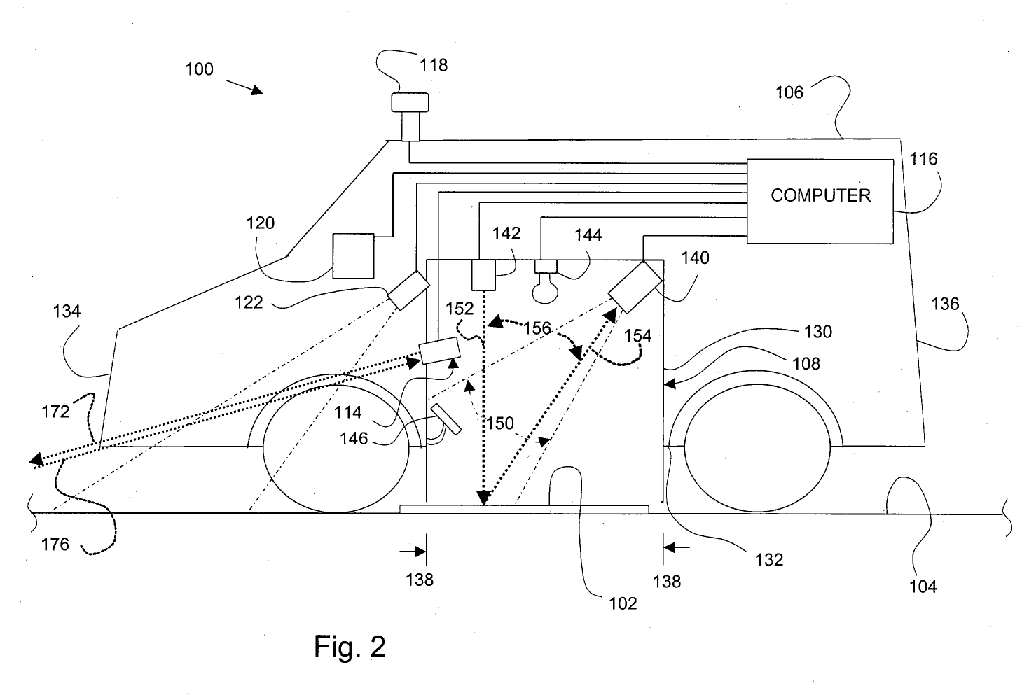

FIGS. 1 and 2 show a block diagram and a schematic side view, respectively, of a vehicle-mounted system 100 for inspecting, measuring and/or evaluating road markings according to the invention. The system 100 measures specific characteristics or parameters of a road marking 102 applied to a road surface 104. The specific characteristics or parameters measured include, for example, color, thickness, and retro-reflectivity. The road marking 102 is, for example, a dried paint film or a thermoplastic or thermosetting polymeric film composition on the road surface 104.

Specifically, the system 100 includes a vehicle 106 and a measurement system 108. The vehicle 106 is preferably a self-propelled commercially available motor vehicle such as an automobile, truck, minivan or SUV that is capable of ordinary highway travel. Alternatively, the vehicle 106 can be a trailer having the measurement system 108 mounted thereon.

The measurement system 108 includes a plurality of measurement subsystems. Preferred subsystems include a color measurement subsystem 110, a thickness measurement subsystem 112, and/or a retro-reflectivity measurement subsystem 114.

The measurement system 108 communicates with a computer 116, for example, a commercially available PANASONIC brand laptop computer having a 1 Gigahertz CPU, 256 Megabytes of Random Access Memory (RAM), a 30 Gigabyte hard drive, and a firewire port. The computer 116 also communicates with a global positioning device 118 and a guidance apparatus, which includes a monitor 120 and a guidance camera 122.

The subsystems 110, 112, 114 are disposed in a housing 130, and the guidance camera 122 is preferably adjacent to, or mounted on, the housing 130. The housing 130 is mounted to the vehicle 106. In particular, the housing 130 is mounted to an undercarriage 132 of the vehicle 106. Alternatively, the housing 130 can be mounted to a side, a front 134 or a rear 136 of the vehicle 106, and the guidance color camera 122 is mounted to the inside or outside of the housing 130, or is spaced from the housing 130, but has a direct view of the road surface 104.

The housing 130 is generally box-like and has sidewalls with inner surfaces, a top, and an optically transparent bottom end. The inner surface that is proximate to the front 134 of the vehicle 106 is the front inner surface of the housing 130. The housing 130 is preferably positioned above a portion 138 of the road surface 104 to be measured at a particular period of time. Because the vehicle 106 can travel over a road, the portion 138 changes as the vehicle 106 moves along the road.

Included with and disposed at a bottom peripheral edge of the housing 130 is an opaque flexible sheet or apron (not shown) that extends around the entire periphery and from the bottom edge to the road surface 104 so as to bridge the gap between the bottom edge and the road surface 104. This allows the bottom edge of the housing 130 to be positioned in close proximity, but not in contact with, the road surface 104, which prevents the housing 130 from becoming damaged due to contact between the road surface 104 and the housing 130. The opaque flexible sheet or apron and the housing 130 block ambient light from striking the portion 138 of the road surface situated beneath the optically transparent bottom end of the housing 130.

The subsystems can, but need not, include some shared and non-shared components. Preferably, the subsystems include at least the following components: a high-resolution color image camera or sensor 140; a laser line generator 142; a white light source 144; and a plurality of color samples 146.

Color samples 146 are preferably mounted to the front inner surface of the housing 130 facing rearward. Color samples 146 serve as reference colors or standards for the color of the road marking being measured. Accordingly, if white, yellow and blue road markings are to be measured and evaluated, white, yellow and blue, respectively, color samples 146 would be used. Color samples 146 having known spectral qualities are used, and such color information is sent to the computer 116.

The white light source 144 is preferably mounted on the top inner surface of the housing 130. In the presently preferred embodiment, the white light source 144 is a high frequency fluorescent bulb, preferably operating with 30 watts of power. The white light source 144 provides a diffuse white light to the interior of the housing 130 and to the portion 138 of the road surface 104 situated beneath the optically transparent bottom end of the housing 130. Accordingly, the white light source 144 can simultaneously illuminate a road marking 102 to be evaluated and measured, the portion 138 of the road surface 104, and color samples 146 within the housing 130.

The color sensor 140 is preferably a commercially available high-resolution progressive-scan color video camera that provides output information to the computer 116. The sensor 140 is preferably mounted such that at least the lens projects into the housing 130, as discussed above, and is oriented relative to the road surface 104 and the housing 130 so that the sensor 140 has a field of view 150. The field of view 150 encompasses both the portion 138 of the road surface 104 and the color samples 146 mounted to the front inner surface of the housing 130. The output information comprises digital color image information and is communicated to the computer 116 digitally, preferably via the firewire port. The color image sensor 140 preferably communicates a color image of the field of view 150 to the computer 116 at predetermined intervals of time to facilitate determinations regarding the reliability and accuracy of the color measurements. Alternatively, the sensor 140 supplies information on a real time basis to the computer 116. The computer 116 either receives the information as it is communicated, or can sample the data stream at predetermined intervals.

The computer 116 calculates the color of the road marking 102 using the output from the sensor 140. The output includes differences between the color of the road marking 102 and the color of a corresponding color sample 146 as obtained by the color image sensor 140. The computer 116 uses a self-calibrating algorithm to calculate an actual or true color of the road marking 102 regardless of color fluctuations of the light source 144 or other instability of the color properties of the color measurement system 112.

With reference to the thickness measurement system 112, the laser line generator 142 preferably has 90-degree uniform line optics, and operates on 20 milliwatts of power. It will be appreciated that the color or spectrum of the laser light will be dependant on the type of laser used. In a preferred embodiment, the laser line generator 142 is a semiconductor laser with a 650-nanometer spectrum.

The laser line generator 142 projects a laser beam 152 as a laser line 154, that is, the laser beam 152 is directed toward the road surface and scanned back and forth in a plane that is perpendicular to a plane defined by the road surface. Thus, rather than a single beam or a single point 104, a two dimensional line is projected onto the portion 138 of the road surface. A portion of the laser beam 152 reflects of the portion 138 of the road surface as reflected laser light 154. Further, the reflected laser light 154 consists of light reflected by both the road surface 104 and by the road marking 102. Accordingly, the length of the laser line 154 is sufficient to cover a variety of marking types, for example, single or double line types.

Preferably, the plane in which the laser beam 152 is projected toward the portion 138 of the road surface 104 is about 90 degrees with respect to the plane of the road surface 104. Directing the laser beam 152 at an angle of about 90 degrees relative to the plane defined by the road surface 104 provides a more accurate thickness measurement than is obtainable using a more acute or obtuse angle relative to perpendicular.

The thickness of the road marking produces a height difference between that portion of the road surface on which has been applied a road marking and that portion of the road on which no road marking has been applied. The portion of the laser beam 152 striking the road marking will reflect as road marking reflected light 156 at an angle that is different from or shifted away from that portion of the laser beam 152 that reflects as non-road marked reflected light 158 from the non-road marked portion of the surface of the road. Accordingly, the road marking reflected light 156 forms a first angle 162, and the road surface reflected light 158 forms a second angle 164 that is different than the first angle 162, relative to the laser beam 152. The difference between the first angle 162 and the second angle 165 is used to determine the height that the road marking 102 extends above the road surface and thus the thickness of the applied road marking.

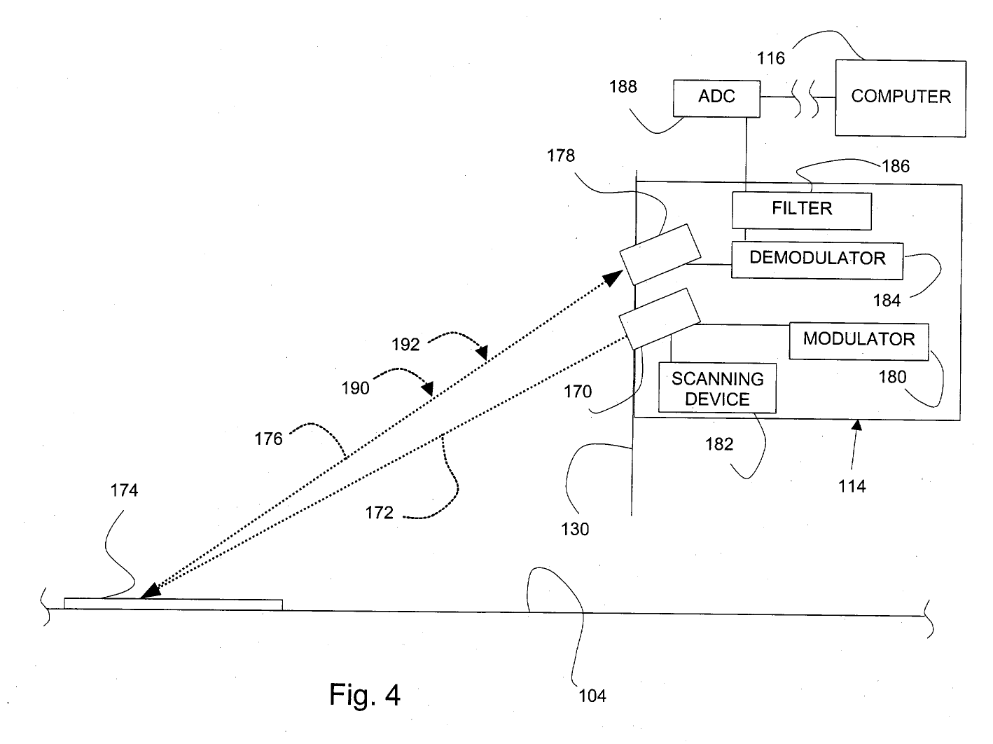

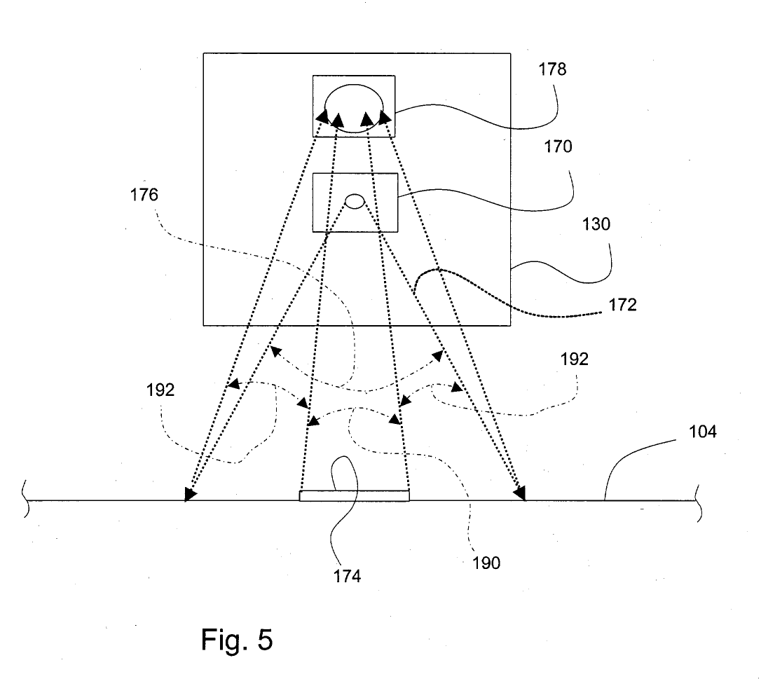

The retro-reflectivity measurement system 114 is discussed with reference to FIGS. 4 and 5. The retro-reflectivity measurement system 114 is mounted at the front end of the housing 130, alternatively, the retro-reflectivity measurement system 114 can be mounted in any location having an unobstructed view of the road surface 104 and the road markings disposed thereon.

Retro-reflectivity is defined as the ability of a material to reflect light that is striking the material back to the source of the light. Both the angle of incidence and the angle of reflection are generally measured with reference to normal, which is a line that is perpendicular to the plane of the surface of the material. For retro-reflectivity, the angle of incidence is the same as the angle of reflection, and the incident and reflective paths of the light are parallel to each other. In contrast, reflective materials reflect light striking the material—at an angle of incidence—away from the material at an angle of reflection that is equal and opposite normal relative the angle of incidence. Accordingly, retro-reflective materials are commonly used in traffic and safety equipment to increase visibility because the light striking the retro-reflective materials is reflected such that the retro-reflective materials are highly visible, particularly at night.

The retro-reflectivity measurement system 114 includes an infrared laser light source 170. Generally, the infrared laser light source 170 points forward at an adjustable angle relative to the road surface 104, and emits a laser beam 172 toward a road marking 174 that is situated a distance away from the vehicle 106, preferably forward of the vehicle 106. The beam 172 is reflected off of the road marking 174. A high sensitivity infrared sensor 178 detects the reflected beam 176, and provides high resolution and low noise of the beam 176 and is, for example, an electrically cooled infrared semiconductor photodiode.

The retro-reflectivity measurement system 114 includes a high frequency generator or modulator 180 and a scanning device 182, which control the infrared laser light source 170, a demodulator 184, a narrow band high frequency filter 186 and an Analog-Digital converter (ADC) 188.

The scanning device 182 moves the laser beam 172 in a pattern that generates a line so as to also reflect off of an area of the road surface 104 adjacent to the road marking 174. That is, the line overlays a portion 190 of the road marking 174 and a portion 192 of the un-marked road surface 104 (similar to the laser line generator 142 disclosed hereinabove).

The reflected beam 176 differs from the outgoing beam 172 in that the reflected beam 176 from portions 190, 192 differ from each other. The first portion 190 is retro-reflected from the road marking 174, and the second portion 192 is a relatively weak reflection off of portions of the road surface 104 adjacent to the road marking 174.

The detector 178 is an analog style detector, and transforms the reflected laser beam 176 into an analog signal, which is communicated to the Analog-Digital converter 188 to create a digital representation of the reflected beam 176 and communicate the digital representation to the computer 116. The digital representation is convenient for usage in the computer 116. The modulator 180 and demodulator 184 cooperate to provide discrimination of the laser light from the ambient light.

The global positioning device 118 is preferably a global positioning satellite (GPS) receiver. Suitable GPS receivers are commercially available from, for example, Garmin International, Inc. (Olathe, Kans.) and GPS Solutions, Inc., which is a division of Raco Industries, Inc. (Cincinnati, Ohio). In alternative embodiments, other positioning devices, such as an encoder wheel or the like, can be used.

With reference to the driver guidance apparatus, the camera 122 is mounted inside the housing 130 facing toward the front of the vehicle 106. The monitor 120 is mounted inside the driver cabin of the vehicle 106 within the viewing area of the driver. The arrangement and operation of the camera 122 and the monitor 120 provides information to the driver regarding the exact position of the housing 130 relative to the road marking 102. The guidance apparatus thus aids the driver in following the road markings disposed along the road surface while the vehicle 106 is in motion. Accordingly, the driver can maintain a constant position of the subject road marking relative to various subsystems 110, 112, and 114 of the measurement system 108.

The computer 116 can receive, process, evaluate and output a variety of valuable road marking data including thickness measurements, color analyses, retro-reflectivity measurements, global positioning data, time information and relative distances information. The computer 116 either communicates the data to a user in a usable format, or stores the data in a data storage media 198 for future analysis. Thus, the computer 116 can store inspection results and/or display both the raw, evaluated data and/or trend information either in real-time or in archival form.

The system 100 further provides a flexible mount, not shown, which places the measurement system 108 in an operational position on the vehicle 106. The mount allows the housing 130 to maintain a desired orientation and spacing relative to the road surface 104 during operation of the vehicle 106.

During operation, the vehicle 106 moves along a road over the road surface 104 and measures a plurality of road markings sequentially. That is, one of the plurality of road markings is the subject road marking 102 that is being measured for color and thickness at a particular time, while another road marking 174, which is spaced a predetermined distance ahead of the vehicle 106, is measured for retro-reflectivity at about the same time as the color and thickness measurements. During the measurements, the speed of the vehicle 106 is in a range of from about zero to about an average highway speed (e.g., about 65 miles per hour).

The guidance camera 122 of the guidance apparatus provides the driver with information about the position of the measurement system 108 relative to the road marking 102 being measured for color and thickness using a live or real-time image of the road surface 104. The driver views the monitor 120 and orients the vehicle 106, and more particularly the housing 130, so as to pass over road markings that are to be measured. In particular, the housing 130 provides the necessary protection from ambient light contamination to allow the measurement sub-systems 110 and 112 to make accurate color and thickness measurements.

The driver moves the vehicle 106 forward and, as the road markings pass in front of and/or under the housing 130, the measurement sub-systems 110-114 measure color, thickness and retro-reflectivity of the road markings. The measurements are communicated to the computer 116 via the firewire.

In particular, the color image sensor 140 generates an image that includes the road marking 102 and the color samples 146. The image is acquired by the computer 116 and placed in the working memory of the computer 116. The computer 116 generates true color information based on the image supplied by the sensor 140.

The laser line generator 142 projects a laser line off of the road surface 104 and the road marking 102. The sensor 140 detects the reflected portions 156, 158 and their respective angles 162, 164 and communicates the information regarding the reflected portions 156, 158 and/or angles 162, 164 to the computer 116. That is, the sensor 140 detects a difference between the laser light portion 156 reflected from the road marking 102 and the laser light that is reflected simultaneously from the road surface 104. The difference in the reflective angles 162, 164 of the laser line 154 reflecting from the road marking 102 and the road surface 104 allows for a thickness determination by the computer 116. Thus, the sensor 140 captures an image and generates output so as to determine both color and thickness of the road marking 102. The system 112 samples at a rate in a range of from about 3 to about 10 inspections per second.

Averaging and noise filtering techniques obtain a high degree of accuracy of the color and thickness measurements. For example, if the resolution of the sensor 140 is 1280×1024 elements, and the angle of the laser beam 152 is about 45 degrees relative to the road surface 104, a precision of about +/−50 micrometers can be obtained. Averaging can also be utilized so as to increase the resulting measurement accuracy of measurements taken while the vehicle 106 is moving.

Preferably, the system 112 automatically detects the position and number of markings under the housing 130. This automatic function can reduce the accuracy demands on the driver in following road markings.

Simultaneously with the color and thickness measurements, the laser source 170 generates an infrared laser beam 172, and the scanner 182 scans the beam 172 back and forth across the road surface 104 in a direction transverse to the direction of travel of the vehicle 106 (if the vehicle 106 is moving). The high frequency generator 180 modulates the infrared laser beam 172, at about, for example, 10-20 kilohertz (kHz). The beam 172 is reflected off of both the road surface 104 and the road marking 174 that is located ahead of the vehicle 106.

The detector 178 receives the reflected beam 176 and the portions 190, 192, and responds by generating and communicating analog image information through the demodulator 184 and the narrow band high frequency filter 186. The narrow band high frequency filter 186 filters a middle frequency that is about equal to the modulation frequency of the high frequency generator 180. The demodulator 184 demodulates the reflected beam 176. The modulation/demodulation and, if present, the filtering, ensures that only the reflected laser light 176 from the laser source 170 is used in the retro-reflectivity measurements. This precludes the computer 116 from using ambient light information in the retro-reflectivity calculations even in direct sunlight conditions, incoming traffic light sources, shades, etc without interference from these additional sources of light. When the retro-reflectivity measurement system 114 is used at night, sunlight is naturally not an issue, thus the computer 116 can further determine whether the system 100 is being operated in day, evening or night conditions. The computer 116 can then adjust the calculations to compensate for such operating conditions accordingly (e.g., adjust for sunlight during the day and for oncoming headlight beams at night).

The use of the infrared laser allows increased laser power usage. As a result, a less sensitive and less expensive photo sensor may be used in the detector 178. The use of modulated/demodulated light reduces or eliminates a need for an infrared optical filter, thus increasing the overall sensitivity and decreasing the cost of the retro-reflectivity measuring system 114.

The computer 116 compares the level of the reflected laser beam 176 from the road marking 174 and the adjacent road surface 104 both to locate the road marking 174 and to calculate the retro-reflectivity degree of the road marking 174 relative to the road surface 104 adjacent to the road marking 174.

The global positioning device 118 provides both the current position of the vehicle 106 and the reference time information to the computer 116. That is, the computer 116 acquires the current time and the position information from the global positioning apparatus 118, preferably at predetermined intervals, for example, once per second. Measurements made by the measurement apparatus 108 between these time intervals are filtered and averaged by the computer 116. The accumulated results, including the time and position information, are communicated to the data storage device 198.

In particular, the computer 116 receives the data or information from the measurement systems 110, 112, and 114 and time and geographic position information from the global positioning device 118, and optionally video feed information from the guidance apparatus. The information is processed and is stored in the data storage device 198. The results are also displayed on the monitor 120, optionally on the separate computer screen.

The stored information from the storage device 198 is further analyzed using mapping software, such as, for example STREETS AND TRIPS, which is commercially available from Microsoft Corporation (Redmond, Wash.) and other tools. Software packages, for example IDVision-2000 MACHINE VISION and MATROX MIL VISION LIBRARY, which are commercially available from Intelligent Devices Inc. (Toronto, ON, Canada) and Matrox Electronic Systems Ltd. (Dorval, QC, Canada), respectively, are resident in the memory of the computer 116. The packages evaluate the raw data and determine measurement information, such as color, thickness and retro-reflectivity, from the raw data. The measurement information is preferably associated with corresponding geographic data and the time of the measurement. A suitable database program, such as, for example EXCEL or ACCESS, which are commercially available from Microsoft Corporation, provides the associations. Additional information, such as traffic, vehicle speed, weather conditions, and the like, can also be inputted into the computer 116 and associated with the collected measurement and other data.

It is thereby possible to generate a map and tables of parameters of road markings. The map or tables are then used to coordinate repair and maintenance efforts of the road markings that show a need for such. Additionally, trend information can be generated that is useful to predict and determine wear rates and product performance.

While it is intended that the above-described embodiments be used in a quality control (QC) type application or the like, other embodiments are also contemplated. For example, an alternative embodiment comprises a unit suitable for use during the application of road markings. The unit would include only desired measurement sub-systems, and would be mounted on, for example, a paint line sprayer truck, along with the components necessary for the measurement sub-system(s) to operate. As described hereinabove, other measurement sub-systems can be added, and the measurement sub-systems can used independent and/or from each other, provided that the necessary components to complete the measurement sub-system are present.

The operation of the paint sprayer would lay down a paint line on the road surface, and a thickness measurement system, for example, would measure the thickness of the wet paint line immediately thereafter. Accordingly, the application of the paint could be controlled through a feedback loop to maintain a predetermined thickness. This can be especially useful if the application of the paint line is to cover an existing worn paint line. Further, the thickness measurements could be logged as, for example, proof of compliance with application standards. The apparatus is a useful tool for confirming that road markings, as applied, meet or exceed contract specifications.

The embodiments described herein are examples of structures, systems and methods having elements corresponding to the elements of the invention recited in the claims. This written description may enable those skilled in the art to make and use embodiments having alternative elements that likewise correspond to the elements of the invention recited in the claims. The intended scope of the invention thus includes other structures, systems and methods that do not differ from the literal language of the claims, and further includes other structures, systems and methods with insubstantial differences from the literal language of the claims.

What is claimed is:

1. An apparatus for measuring at least one attribute of a road marking disposed on a road surface comprising:
a vehicle configured for travel over the road surface;
a computer transported by the vehicle; and
a measurement system transported by the vehicle;
wherein the measurement system comprises a color measurement subsystem that:
measures the color of the road marking with reference to a standard color sample;
generates color measurement data based on the color measurement; and
communicates the color measurement data to the computer.

2. The apparatus as defined in claim 1 wherein the measurement system further comprises a thickness measurement subsystem that:
measures the thickness of the road marking disposed on the road surface;
generates thickness measurement data; and
communicates the thickness measurement data to the computer.

3. The apparatus as defined in claim 1 wherein the measurement system further comprises a retro-reflectivity measurement subsystem that:
measures the retro-reflectivity of the road marking disposed on the road surface;
generates retro-reflectivity measurement data; and
communicates the retro-reflectivity measurement data to the computer.

4. The apparatus as defined in claim 2 wherein the measurement system further comprises a retro-reflectivity measurement subsystem that:
measures the retro-reflectivity of the road marking disposed on the road surface;
generates retro-reflectivity measurement data; and
communicates the retro-reflectivity measurement data to the computer.

5. The apparatus as defined in claim 1 wherein the vehicle is a self-propelled vehicle.

6. The apparatus as defined in claim 1 wherein the vehicle is a towed vehicle.

7. The apparatus as defined in claim 1 wherein the color measurement subsystem measures the color of the road marking with reference to the standard color sample while the vehicle is moving relative to the road surface.

8. The apparatus as defined in claim 1 wherein the measurement system is disposed in a housing that is mounted on the vehicle, and the housing has an optically transparent bottom end facing the road surface.

9. The apparatus as defined in claim 8 wherein the color measurement subsystem comprises:
a color camera having a field of view;
a white light source; and
a standard color sample for reference by the color measurement system, and the housing defines an interior volume and is configured to block or reduce outside light from entering into the interior volume from outside of the housing, the white light is operable to provide an interior light to the interior volume of the housing, the color sample and the road marking being simultaneously within the field of view of the color camera during a color parameter measurement of the road marking.

10. The apparatus as defined in claim 9 wherein the color sample is one of a plurality of color samples, each color sample having a known spectral quality that corresponds to a predetermined road marking color.

11. The apparatus as defined in claim 2 wherein the thickness measurement subsystem comprises:
a laser source;
a laser scanner communicating with the laser source; and
a camera, the laser source being operable to emit a beam of laser light, the scanner being operable to scan the beam to generate a laser line such that a first portion of the line reflects off of the road surface at a first angle, and a second portion of the line reflects off of the road marking at a second, different angle, and the camera being operable to detect a difference in the first and second angles relative to each other, whereby the thickness parameter of the road marking is determine based on the difference in the first and second angles.

12. The apparatus as defined in claim 3 wherein a second road marking is located a predetermined distance forward of the vehicle, and the retro-reflectivity measurement subsystem comprises:
a laser source that is operable to emit a laser beam;
a laser scanner that communicates with the laser source, and that is operable to scan the laser beam to generate a laser line such that a first portion of line reflects off of the road marking, and a second portion of the line reflects off of the road surface adjacent to the road marking; and
a laser detector that is operable to detect the first and second portions of the reflected laser line, the first and second portions having differing reflective strengths relative to each other, whereby the retro-reflectivity parameter of the second road marking is determined based on the differing reflective strengths of the first and second portions.

13. The apparatus as defined in claim 1 further comprising a guidance apparatus, the guidance apparatus comprising a camera and a monitor, the camera mounts to a housing and generates an image of a portion of the road surface proximate to the housing, and communicates with the image to the monitor, the monitor is located within a field of vision of a driver of the vehicle and receives and displays the image, whereby the driver can view the image displayed on the monitor and operate the vehicle so that the housing is in a predetermined orientation relative to the road marking on the road surface.

14. An apparatus for measuring at least one attribute of a road marking disposed on a road surface comprising:
a vehicle configured for travel over the road surface;
a computer transported by the vehicle; and
a measurement system transported by the vehicle;
wherein the measurement system comprises a thickness measurement subsystem that:
measures the thickness of the road marking disposed on the road surface;
generates thickness measurement data; and
communicates the thickness measurement data to the computer.

15. The apparatus as defined in claim 14 wherein the measurement system further comprises a retro-reflectivity measurement subsystem that:
measures the retro-reflectivity of the road marking disposed on the road surface;
generates retro-reflectivity measurement data; and
communicates the retro-reflectivity measurement data to the computer.

16. The apparatus as defined in claim 14 wherein the thickness measurement subsystem comprises:
a laser source;
a laser scanner communicating with the laser source; and
a camera, the laser source being operable to emit a beam of laser light, the scanner being operable to scan the beam to generate a laser line such that a first portion of the line reflects off of the road surface at a first angle, and a second portion of the line reflects off of the road marking at a second, different angle, and the camera being operable to detect a difference in the first and second angles relative to each other, whereby the thickness parameter of the road marking is determine based on the difference in the first and second angles.

17. The apparatus as defined in claim 15 wherein a second road marking is located a predetermined distance forward of the vehicle, and the retro-reflectivity measurement subsystem comprises:
a laser source that is operable to emit a laser beam;
a laser scanner that communicates with the laser source, and that is operable to scan the laser beam to generate a laser line such that a first portion of line reflects off of the road marking, and a second portion of the line reflects off of the road surface adjacent to the road marking; and
a laser detector that is operable to detect the first and second portions of the reflected laser line, the first and second portions having differing reflective strengths relative to each other, whereby the retro-reflectivity parameter of the second road marking is determined based on the differing reflective strengths of the first and second portions.

18. The apparatus as defined in claim 17 wherein the retro-reflectivity measurement system further comprises a modulator that communicates with the laser source, and a demodulator and a filter that communicate with the detector, the modulator is operable to modulate the laser beam, and the demodulator is operable to demodulate the reflected and modulated first and second portions of the laser line, the detector is operable to generate a signal in response to detecting the modulated and reflected first and second portions of the laser line, and the filter is operable to filter the signal, whereby the filter, the modulator, and the demodulator cooperate with each other to reduce or eliminate interference caused by ambient light contacting the detector so that the signal is dependent on the detection of the reflected first and second portions of the laser line only.

19. The apparatus as defined in claim 14 further comprising a global positioning device that is operable to communicate a current time value and geographic position information of the vehicle to the computer.

20. A method for measuring a road marking parameter of a road marking that is disposed on a road surface, comprising:
providing a vehicle that is operable to transport a road marking parameter measurement system, the measurement system comprising a laser line generator that is operable to project a laser line, and detector that is operable to measure a laser line reflection;
operating the vehicle so that the measurement system is moving relative to the road surface;
operating the measurement system to project laser line such that a first portion of the line is reflected off of the road marking at a first angle and second portion of the line is reflected off of the road surface adjacent to the road marking at a second angle;
detecting the reflected first and second portions of the line with the detector; and
determining a thickness of the road marking based on a difference of the first angle relative to the second angle.

21. The method as defined in claim 20 wherein the measurement system further comprises a color measurement system, and the detector is a color camera having a field of view, and at least a portion of the road marking and a reference color sample are beneath a housing and in the field of view of the camera, the method further comprising the steps of:
illuminating an interior of the housing with a white light so that the color sample and the portion of the road/marking are illuminated;
acquiring a color image with the camera that includes both the portion of the road marking and the color sample; and
determining the color of the road marking based on the color image.

22. The method as defined in claim 20 further comprising the steps of:
reflecting a laser beam off of a second road marking and a portion of the road surface that is adjacent to the second road marking such that the reflected laser beam forms a first angle of incidence relative to the road surface that is about the same as a second angle of incidence formed by light emitted from a headlight of the vehicle relative to the road surface;
detecting the reflected laser beam; and
determining a difference in retro-reflectivity of the second road marking, and the road surface adjacent to the second road marking, based on the detected reflected laser beam, whereby the difference in retro-reflectivity is the retro-reflectivity of the road marking.
